(19) United States
(12) Patent Application Publication
(10) Pub. No.: US 2022/0077788 A1
(43) Pub. Date: Mar. 10, 2022

(54) ISOLATED DC-DC POWER CONVERTER WITH LOW RADIATED EMISSIONS

(71) Applicant: Texas Instruments Incorporated, Dallas, TX (US)

(72) Inventors: Tarunvir Singh, Jalandhar (IN); Suvadip Banerjee, Bangalore (IN); Sreeram Subramanyam Nasum, Bangalore (IN)

(21) Appl. No.: 17/236,931

(22) Filed: Apr. 21, 2021

(30) Foreign Application Priority Data
Sep. 4, 2020 (IN) 202041038235

(51) Int. Cl. H02M 3/335; H02M 1/088

(52) U.S. Cl. CPC H02M 3/33571; H02M 1/088

(57) ABSTRACT

DC-DC power converter architecture is disclosed. In an example, an integrated circuit includes an H-bridge switching circuit operatively coupled with a transformer. The switching circuit is compensated to account for parasitic differences between the high-side (power) and low-side (ground). For instance, PMOS transistors connected to the high-side are sized larger to substantially match on-resistance of NMOS transistors connected to the low-side (e.g., such that the on-resistances are all within a tolerance of one another, or within a tolerance of a target on-resistance value), and the NMOS transistors include additional gate-drain capacitance to substantially match gate-drain capacitance of the larger PMOS transistors (e.g., such that the gate-drain capacitances are all within a tolerance of one another, or within a tolerance of a target gate-drain capacitance value). In addition, the transformer is configured with physical symmetry, such that the inductive and capacitive mid-points of the transformer are substantially co-located.

### RELATED APPLICATION

This application claims the benefit of and priority to IN provisional application number 202041038235 filed on Sep. 4, 2020, which is herein incorporated by reference in its entirety.

### FIELD OF THE DISCLOSURE

This disclosure relates to isolated DC-DC power converters, and more particularly, to techniques for reducing radiated emissions in integrated isolated DC-DC power converters.

### BACKGROUND

Electromagnetic compatibility (EMC) standards set limits on electromagnetic interference (EMI) in electrical and electronic devices. For instance, such standards define the frequency range and maximum allowable magnitudes of unintended radiated emissions, to prevent such emissions from interfering with the intended operation or emissions of other devices and systems (such as communication devices that use an assigned frequency range for radio frequency communication). Although there are many EMC standards for various industries, one widely recognized such standard is referred to as the International Special Committee on Radio Interference (also, CISPR), which is part of the broader International Electrotechnical Commission (IEC).

Commercial products and technologies must comply with the relevant EMC standards. Such compliance can be particularly challenging as form factors continue to scale downward. For instance, one relatively newer area of electronics involves the integration of transformers and supporting circuitry into integrated circuit packages. On one hand, the integration of a given transformer and its related circuitry into an integrated circuit package garners a substantial space-savings on the printed circuit board (PCB) on which the integrated transformer is populated. On the other hand, such integrated transformers tend to introduce higher radiated emissions. One possible approach to reduce radiated emissions is to connect a so-called stitching capacitor between the primary and the secondary, which allows for common-mode currents to couple across the galvanic barrier of the transformer and therefore a reduction in the level of radiated emissions. The stitching capacitor can be either a discrete component populated on the PCB or an interlayer capacitor embedded within the PCB itself. Unfortunately, stitching capacitors are susceptible to reliability problems, particularly in applications subjected to electrostatic discharge and other potentially high voltage transients. Thus, there is a need for techniques to reduce radiated emissions.

### SUMMARY

Integrated isolated DC-DC power converter architecture is disclosed.

In one example, an integrated circuit includes a transformer and an H-bridge switching circuit. The transformer includes a primary-side inductor and a secondary-side inductor. Each of the primary-side inductor and the secondary-side inductor include a first half-cell portion and a second half-cell portion that is a replica of the first half-cell portion except that it is rotated about an axis. The two half-cell portions are connected to one another to provide the corresponding inductor. The H-bridge switching circuit is operatively coupled to the primary-side inductor. The H-bridge switching circuit includes first and second transistors of a first polarity, and third and fourth transistors of a second polarity. The first, second, third, and fourth transistors have substantially the same on-resistance and substantially the same gate-drain capacitance.

In another example, an integrated circuit includes a transformer and an H-bridge switching circuit. The transformer includes a primary-side inductor and a secondary-side inductor. Each of the primary-side inductor and the secondary-side inductor includes a first portion and a second portion that is a replica of the first portion except that it is rotated about an axis. The two portions are connected to one another to provide the corresponding inductor. An imaginary line of symmetry divides each of the primary-side and secondary-side inductors into the respective first and second portions. The H-bridge switching circuit is operatively coupled to the primary-side inductor. The H-bridge switching circuit includes first and second transistors of a first polarity, and third and fourth transistors of a second polarity. The first, second, third, and fourth transistors each have an on-resistance within 10% of a same target on-resistance, and a gate-drain capacitance within 10% of a same target gate-drain capacitance.

In another example, an integrated circuit includes a transformer, a rectifier, a supply network, and an H-bridge switching circuit. The transformer includes a primary-side inductor and a secondary-side inductor, wherein an imaginary line of symmetry divides each of the primary-side and secondary-side inductors into first and second portions. The rectifier is operatively coupled to the secondary-side of the transformer, and includes a plurality of diodes arranged and connected symmetrically about the line of symmetry. The supply network includes a voltage supply portion and a ground portion, wherein the voltage supply portion is symmetrical to the ground portion about the line of symmetry. The H-bridge switching circuit is operatively coupled to the primary-side inductor. The H-bridge switching circuit includes first and second p-type metal oxide semiconductor field effect transistors (MOSFETs) connected to the voltage supply portion of the supply network, and third and fourth n-type MOSFETs connected to the ground portion of the supply network. The first, second, third, and fourth MOSFETs each have an on-resistance within 10% of a same target on-resistance, and a gate-drain capacitance within 10% of a same target gate-drain capacitance. In addition, the first and second portions of the primary-side inductor each have a primary-side feedpoint and are symmetric about the line of symmetry, except for a portion attributable to movement of the primary-side feedpoint of one of the portions of the primary-side inductor to be physically closer to the primary-side feedpoint of the other of the portions of the primary-side inductor. Likewise, the first and second portions of the secondary-side inductor each have a secondary-side feedpoint and are symmetric about the line of symmetry, except for a portion attributable to movement of the secondary-side feedpoint of one of the portions of the secondary-side inductor to be physically closer to the feedpoint of the other of the portions of the secondary-side inductor.

### BRIEF DESCRIPTION OF THE DRAWINGS

FIG. 1 schematically illustrates an example DC-DC power converter configured with an H-bridge switching circuit and transformer architecture, in accordance with an embodiment of the present disclosure.

FIGS. 2a-d collectively illustrate operational details of an H-bridge switching circuit and transformer architecture, in accordance with some embodiments of the present disclosure.

FIG. 2e illustrates improvements, with respect to radiated emissions, that can be achieved with an H-bridge switching circuit and transformer architecture, in accordance with some embodiments of the present disclosure.

FIGS. 3a-b collectively illustrate an example H-bridge switching circuit configured with R_{ds} matching between NMOS and PMOS transistors, in accordance with an embodiment of the present disclosure.

FIGS. 4a-b collectively illustrate an example H-bridge switching circuit configured with C_{gd} matching between NMOS and PMOS transistors, in accordance with an embodiment of the present disclosure.

FIGS. 5a-b collectively illustrate an example H-bridge switching circuit configured with both R_{ds} and C_{gd} matching between NMOS and PMOS transistors, in accordance with an embodiment of the present disclosure.

FIGS. 6a-b collectively illustrate a transformer configured in accordance with an embodiment of the present disclosure.

FIGS. 6c-d each illustrates an example layout of a primary or secondary inductor of a transformer configured in accordance with an embodiment of the present disclosure.

FIGS. 7a-d collectively illustrate an example half-cell formation process and layout of a primary inductor of a transformer configured in accordance with an embodiment of the present disclosure.

FIGS. 8a-d collectively illustrate an example half-cell formation process and layout of a secondary inductor of a transformer configured in accordance with an embodiment of the present disclosure.

FIG. 9 illustrates an H-bridge switching circuit and transformer architecture, in accordance with another embodiment of the present disclosure.

### DETAILED DESCRIPTION

Techniques are provided herein to reduce radiated emissions in integrated isolated DC-DC power converters. In an embodiment, an isolated power converter includes a driver circuit and a transformer. The driver circuit is implemented on a semiconductor die included in an integrated circuit package that may also include the transformer. In some such cases, for instance, the transformer is a laminate transformer that is also included within the package and wire bonded to connection points of the die. The galvanic barrier of the transformer provides electrical isolation between the primary-side and secondary-side grounds of the converter. The driver circuit includes a control block and an H-bridge switching circuit operatively coupled with the transformer. The H-bridge switching circuit is compensated to account for parasitic differences between the high-side (power) and low-side (ground), which allows for symmetric drive and steady common-mode voltage across the primary of the transformer. For instance, in some example embodiments, the H-bridge switching circuit is implemented with power MOS transistors, wherein PMOS transistors connected to the high-side are sized larger to match on-resistance of NMOS transistors connected to the low-side, and the NMOS transistors include additional gate-drain capacitance to match gate-drain capacitance of the PMOS transistors. In addition, the transformer is configured with physical symmetry, such that the inductive and capacitive mid-points of the transformer are co-located, which allows for reduced common-mode switching current passing between the two isolated grounds via parasitic capacitance that exists between the primary and secondary of the transformer. The physical symmetry of the power converter may be further applied to the control block and/or supply voltage paths, to further decrease common-mode voltage peaks and current. For instance, according to some embodiments, the NMOS and PMOS transistors of the H-bridge switching circuit can be driven by symmetric drive signals from the control block, in a non-overlapping fashion. In such cases, the drive signals are symmetric given the physical layout symmetry of their respective signal paths (e.g., the physically symmetrical paths experience substantially the same parasitic delay); and the drive signals are non-overlapping given a non-overlap drive circuit (e.g., they cannot both be high at the same time). Note that symmetry about an axis with respect to the physical layout of circuitry allows for symmetry with respect to the electrical characteristics (e.g., signal delay, signal rise/fall time, etc.) of the signaling produced by that circuitry. So, for instance, if a first signal path of a first drive signal is physically symmetrical to a second signal path of a second drive signal, then those first and second drive signals can be thought of as being symmetrical to one another. In any such embodiments, note that having a relatively stable common-mode allows for reduced charge transfer across the two grounds and thus reduced radiated emissions. Numerous example embodiments and configurations will be appreciated in light of this disclosure.

General Overview

As previously noted, there is a need for techniques to reduce radiated emissions, particularly with respect to integrated transformers. In more detail, one important and often misunderstood aspect of good industrial system design is proper grounding that is free of ground loops. Depending on the system, a ground isolator in the signal path can be used to eliminate a ground loop. For instance, in the context of a DC-DC converter, the galvanic barrier of a transformer electrically isolates the primary-side input voltage and ground from the secondary-side output voltage and ground. Such an arrangement, however, allows common-mode current to be injected across the two isolated grounds via parasitic capacitance that exists between the primary and secondary windings of the transformer. This current can become asymmetric due to asymmetries of the signal path, which allows for a manifestation of that current at the switching frequency (or a multiple thereof). Complicating this phenomenon is that the ground planes on the printed circuit board (PCB) on which the integrated circuit including the transformer is populated can act as a dipole antenna. This antenna, in conjunction with the manifestation of current flowing between grounds, gives rise to radiated emissions at the converter switching frequency (or a multiple thereof). Given the relatively small feature sizes of integrated transformers, the attendant inductance and capacitance values of that transformer are relatively low, which in turn yields a relatively high switching frequency (e.g., 10 s MHz to 100 s MHz) to transfer power from the primary to the secondary. Such radiated emissions can run afoul of EMC standards or otherwise cause undesired interference.

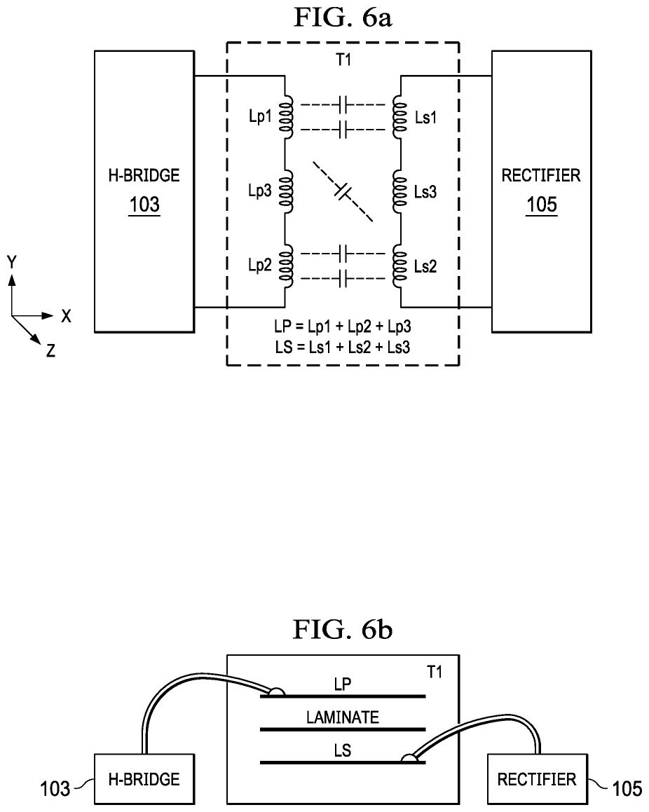

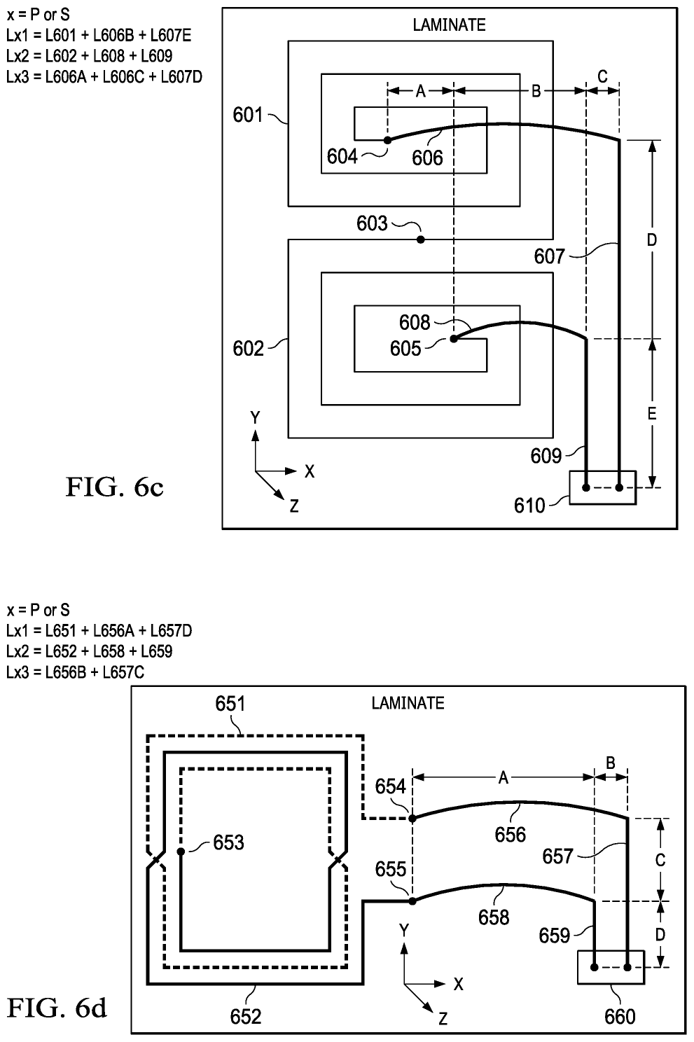

To this end, DC-DC power converter architecture is provided herein which is configured to maintain a relatively steady common-mode voltage across the primary inductor of the converter. In an embodiment, the architecture includes a parasitic-compensated H-bridge switching circuit operatively coupled with a transformer that is physically symmetrical about an axis (although a relatively small degree of asymmetry attributable to feedpoint alignment and/or differences in feedlines can be tolerated, such as further discussed with reference to FIGS. 6c-d, 7a-d, and 8a-d). The architecture is particularly useful in reducing charge transfer across the galvanic barrier of the transformer and between the isolated ground planes, which in turn reduces radiated emissions of the converter. Because the architecture is implemented at a local level (e.g., integrated circuit package and/or die level) rather than a global level (e.g., system level), it is system-independent. Thus, the architecture allows for radiated emissions to be reduced at the source without the need of system level solutions.

In an example embodiment, an integrated circuit that includes a DC-DC power converter is configured with a metal oxide semiconductor (MOS) H-bridge switching circuit operatively coupled to a transformer. The H-bridge switching circuit can be implemented on a semiconductor die included in the package of the integrated circuit. In some such cases, the transformer is a laminate transformer that is included within the integrated circuit package and wire bonded or otherwise interconnected to connection points of the die. In other cases, the transformer may be part of the die, or outside the integrated circuit package such as on and/or within a PCB to which the integrated circuit package is attached. In any such cases, the transformer is symmetric, in that the inductive and capacitive mid-points of the transformer are co-located or otherwise generally at the same geometric location (in all three-dimensions, meaning the mid-points coincide in space, although perfect co-location is not required), rather than being spaced apart from one another as is the case with asymmetric transformer designs. An example symmetric configuration includes the case where the primary and secondary are each implemented with 8-shaped inductors, deposited on opposite sides of an intervening layer of laminate (dielectric material to electrically isolate the primary-side from the secondary-side). When the inductive and capacitive mid-points do not align (such as the case with spiral inductors), asymmetric currents flow across parasitic capacitance between the primary and secondary, and hence between the two isolated grounds, thereby giving rise to radiated emissions.

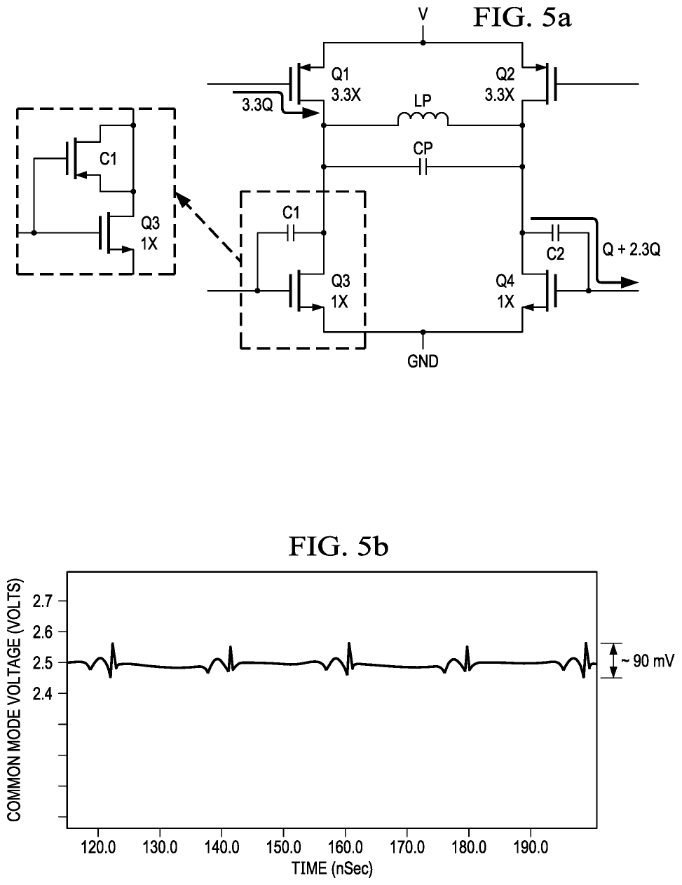

The H-bridge switching circuit can be implemented, for instance, with power MOS field effect transistors (MOSFETs), although other suitable transistor technology (e.g., bipolar junction transistors, BJTs) can be used depending on the particular demands of the given application, as will be appreciated. In any such cases, the H-bridge switching circuit is parasitic-compensated. In more detail, and according to some such embodiments, P-channel MOS (PMOS) transistors connected to the high-side (primary-side power, such as V_{CC}) are sized larger (e.g., 3.3×) to match the on-resistance (R_{ds}) of the N-channel MOS (NMOS) transistors connected to the low-side (primary-side ground). In addition, the low-side NMOS transistors include an additional gate-drain capacitor to match the gate-drain capacitance (C_{gd}) of the high-side PMOS transistors. Such parasitic matching between the PMOS and NMOS power transistors of the H-bridge switching circuit helps to reduce common-mode voltage peaks that manifest across the transformer at the switching frequency or a multiple thereof. In addition, because the drive signals applied to the parasitic-compensated H-bridge switching circuit are non-overlapping (not high at the same time), the resulting drive signals applied to the primary of the transformer are also non-overlapping. In particular, the drive signals applied to the transformer rise and fall in a differential, fashion, such that the two drive signals can never be in the same state (both high or both low). As a result of the parasitic-compensated H-bridge switching circuit, the common-mode voltage of the transformer does not change or is otherwise relatively stable while the converter switches at the switching frequency to transfer power from the primary-side to the secondary-side (such as the example case discussed with reference to FIG. 5b, where the common-mode peak voltage is within a desired threshold). This is in contrast, for example, to a cross-coupled driver where the drive signals applied to the transformer can be both high at the same time, albeit briefly, which in turn gives rise to an asymmetric current that passes via the parasitic capacitance between the primary and secondary windings, which in turn gives rise to radiated emissions at the switching frequency or a multiple thereof.

In some embodiments, the physical symmetry can be applied to still other parts of the signal chain of the power converter, so as to maintain an even more relatively stable common-mode voltage, even in a noisy environment. For instance, in one such embodiment, the power converter further includes a control block operatively coupled to the H-bridge switching circuit, a diode rectifier operatively coupled to the secondary of the transformer and for providing the output of the converter, and a hysteretic comparator operatively coupled across that output. In some such embodiments, the control block includes a digital control, non-overlapping drivers, and pre-drivers, all of which can be implemented in half-cell fashion so as to be physically symmetrical about a given axis. The digital control is programmed or otherwise configured to control the switching of the H-bridge switching circuit to drive the transformer, based on feedback from the hysteretic comparator on the rectifier side. The non-overlapping drivers generate NMOS and PMOS drive signals from the control signals generated by the digital control. The pre-drivers buffer the drive signals from the non-overlapping drivers, and drive the gates of the NMOS and PMOS power FETs of the H-bridge switching circuit with an optimized or otherwise sufficient drive strength. The drive signals are non-overlapping given the non-overlapping drivers (e.g., they cannot both be high at the same time). In addition, the drive signals can be thought of as symmetric given the layout symmetry of their respective signal paths (e.g., both paths experience substantially the same parasitic delay). To this end, the control block can be laid out in a symmetric fashion (e.g., using half-cell design principles) to provide substantially equal delays in both polarity drive signals. In any such cases, and as previously explained, reducing variations in common-mode is helpful in reducing charge transfer across the isolated ground planes and radiated emissions. In some such example embodiments of the present disclosure, the symmetry can be carried through the entire signal chain of the power converter, starting from the digital control and non-overlapping drivers and continuing through the pre-drivers, H-bridge switching circuit, laminate transformer and rectifier.

Still further embodiments may include further symmetrical features. For instance, bond-wires and trace lengths of the voltage supply and ground pathways can be laid out in a symmetrical fashion, so as to provide symmetric power feed paths to the inverter and rectifier circuitry. Such symmetry helps to maintain out-of-phase noise (e.g., (V_{CC}+GND)/2) at a constant level. Likewise, the rectifier can be laid out in a symmetric fashion. Also, decoupling capacitors can be symmetrically connected between the supply and ground of either or both the primary-side and the secondary-side, to help reduce supply noise. As will be appreciated in light of this disclosure, lower supply noise is desirable, because if there is asymmetry in the power converter design, any supply noise can couple to the transformer, thereby causing higher radiated emissions. Thus, decoupling capacitors can be used in cases, for example, where the input and/or output supplies are relatively noisy. In addition, some embodiments include compensations to offset parasitics that introduce asymmetry. For instance, some configurations may experience a parasitic capacitance associated with the primary and secondary die attach pads (priDAP and secDAP). Such a parasitic can manifest, for instance, between the two isolated grounds. In such a case, an additional capacitance can be added between the isolated voltage supplies, as a symmetrical balance to that parasitic capacitance.

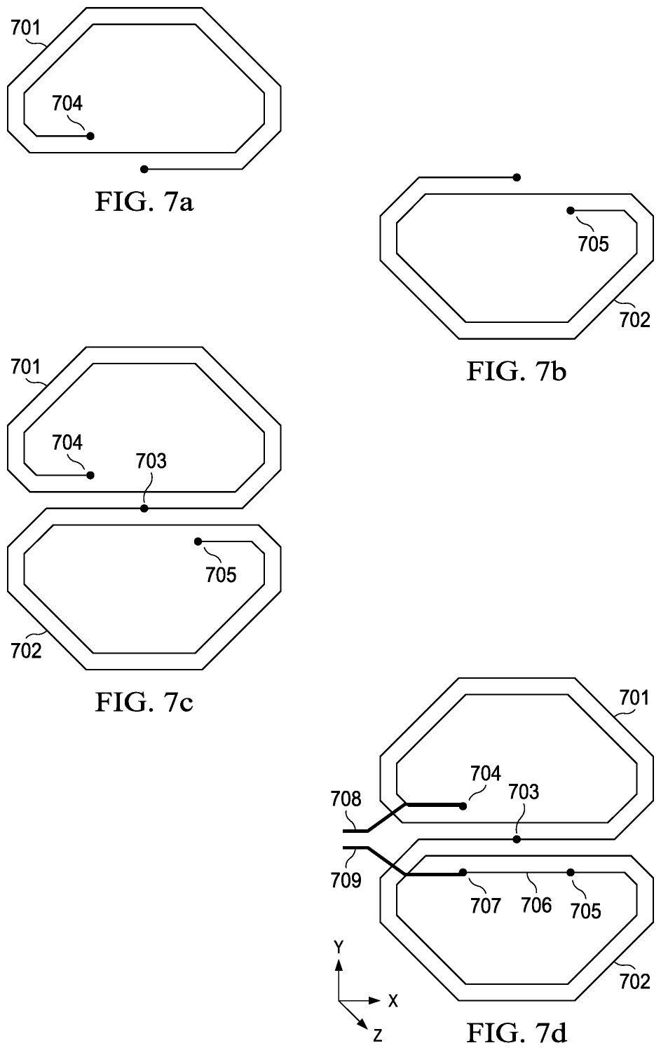

As will be appreciated, references herein to half-cell portions or layout refer to the layout of half of a given circuit or cell. A given cell may be, for instance, a single component such as an inductor, or a multi-part component such as a transformer, or an entire circuit or sub-circuit such as a digital control block. In a more general sense, a cell can be any circuit that can be halved in the design and layout phase of that particular circuit, using a circuit layout tool. Once that half-cell is laid out, the other half of the cell is a mirror image that can be autogenerated by the layout tool used to generate the first half of the cell. As will be further appreciated in light of this disclosure, the reason for using half-cell layout is to, for example, maintain similar parasitics (e.g., routing resistance, routing inductance, and routing capacitance) for both the drive branches of the transformer, and reduce common-mode switching current passing between the two isolated grounds via parasitic capacitance that exists between the primary and secondary of the transformer. Of course, given real world considerations, perfect matching of one half-cell to the other half-cell is not required. To this end, reference herein to a “half-cell” or “half-cell portion” or “replica” or “copy” is not intended to limit the present disclosure to perfectly matched halves. Rather, reasonable sameness-tolerances may be used to accommodate real world process limitations. For instance, minor differences may result between two half-cell inductor portions or two half-cell circuit portions formed by the same process, and the impact of those minor differences on radiated emissions is negligible or otherwise within acceptable limits of a given EMC standard. Likewise, intentional deviations from sameness may be used to accommodate layout preferences and design constraints that cause relatively small amounts of asymmetry between half-cells, as will be appreciated in light of this disclosure. For instance, a relatively small degree of asymmetry between half-cell portions of a transformer inductor can be caused by movement of one of the feedpoints of that inductor, to allow the feedpoints of that inductor to be on the same side and to allow for symmetry of the feedlines to those feedpoints (e.g., as will be discussed with reference to FIGS. 7a-d and 8a-d). Thus, the degree to which one half-cell matches the other half-cell for a given component or circuit can vary somewhat, but still allow for a relatively high degree of symmetry that in turn reduces radiated emissions to within acceptable limits of a given EMC standard, as variously described herein.

Circuit Architecture

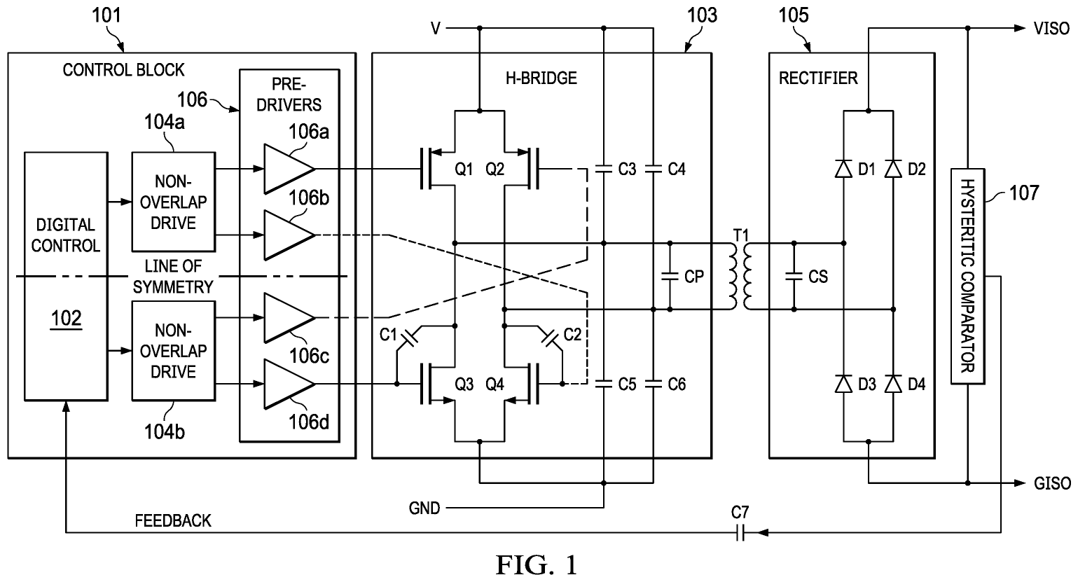

FIG. 1 schematically illustrates an example power converter configured with a symmetric switching bridge and transformer architecture, in accordance with an embodiment of the present disclosure. As can be seen, the power converter of this example case is a DC-DC converter and includes a control block 101, an H-bridge switching circuit 103, a rectifier 105, and a hysteretic comparator 107. A transformer T is operatively coupled between the H-bridge switching circuit 103 and rectifier 105. The control block 101 includes digital control 102, non-overlap drives 104a and 104b, and pre-drivers 106. As can further be seen, the H-bridge switching circuit 103 of this example is implemented with power MOS technology, and includes two P-channel MOSFETs (Q1 and Q2) connected to the high-side (V) and two N-channel MOSFETs (Q3 and Q4) connected to the low-side (GND). The H-bridge switching circuit 103 is further configured with additional features, including capacitors C1-C6 as well as capacitor CP. The rectifier 105 includes diodes D1-D4 and capacitor CS. In other embodiments, these capacitors may be integrated with the transformer T1. Capacitor C7 is connected in the feedback path between the hysteretic comparator 107 and control block 101. Each of these components will be further discussed in turn. The power converter can be implemented as an integrated circuit, wherein at least some portions of the power converter circuitry (e.g., 101, 103, 105, and 107) are formed on a semiconductor die, using standard or proprietary process technologies and materials, as will be appreciated. As previously noted, the transformer T1 can be separate from, and operatively coupled to, the die. In such cases, the die and transformer can both be bonded into the package of the integrated circuit.

In operation, the power converter converts the input voltage (V) to the output voltage (VISO). Note that the input voltage V is referenced to a first ground (GND), and the output voltage VISO is referenced to a second ground (GISO). The first and second grounds are isolated from one another via the galvanic barrier of transformer T1. An example embodiment includes the conversion of 5 volts in to an isolated 5 volts out (5Vin 5Vout), although any input/output voltage scheme can be used, as will be appreciated. In this particular example, the digital control 102 reacts based on feedback received from the hysteretic comparator 107 operatively coupled across the output of rectifier 105, and is configured to generate the control signals that control the switching of the H-bridge switching circuit 103, for drive of the transformer T1. The non-overlap drives 104a and 104b derive symmetric drive signals (pulses) from the control signals generated by digital control 102, and the pre-drivers 106a-d amplify or otherwise buffer those symmetric drive signals so as to drive the respective gates of the MOSFETs (Q1, Q2, Q3, and Q4) of H-bridge switching circuit 103 with a sufficient drive strength. The hysteretic comparator 107 senses the converter output and load condition and generates feedback to which the digital control 102 can react when generating the control signals.

Each of the control block 101, rectifier 105, and hysteretic comparator 107 can each be implemented with standard or proprietary technology, except that they can also be further implemented with a degree of layout symmetry, according to some embodiments of the present disclosure. For example, in some such embodiments: digital control 102 is a standard 2-state (on-off) architecture that drives the power stage (H-bridge switching circuit and transformer T1); non-overlap drives 104a-b are standard circuits to generate 180-degree phased apart clock signals in response to the control signals from digital control 102; and pre-drivers 106 are standard drivers. In such cases, the control block 101, H-bridge switching circuit 103, transformer T1, rectifier 105, and hysteretic comparator 107 collectively operate to provide a hysteretic DC-DC converter, using a standard 2-state digital control architecture to drive the power stage. Numerous configurations can be used, and the present disclosure is not intended to be limited to any particular control block, as will be appreciated.

According to an embodiment of the present disclosure, the components and conductive runs of the control block 101 are laid out in half-cell fashion to ensure equal delays in both drive signals. Such symmetrical layout can be applied to the components and conductive runs making up each of 103, 105, and 107, as well. Different embodiments may have different degrees of symmetry used in conjunction with the parasitic-compensated H-bridge switching circuit 103, depending on the demands of a given application. For example, and with respect to the control block 101, imagine a line of symmetry that passes through the circuit (as represented in FIG. 1 with a dashed line running through the control block 101), such that the componentry and conductive runs making up the non-overlap drive 104a and pre-drivers 106a-b are above the line of symmetry in a certain layout configuration. Such a configuration provides the first half-cell of a symmetric control block 101. The second half-cell can be a flipped version of that same layout configuration (flipped about the line of symmetry), to provide the non-overlap drive 104b and pre-drivers 106c-d. The respective conductive runs from digital control 102 to the corresponding non-overlap drives 104a-b can also be symmetrically laid out in balanced fashion about the line of symmetry, as can the circuitry making up the digital control 102 itself, for substantially complete symmetry.

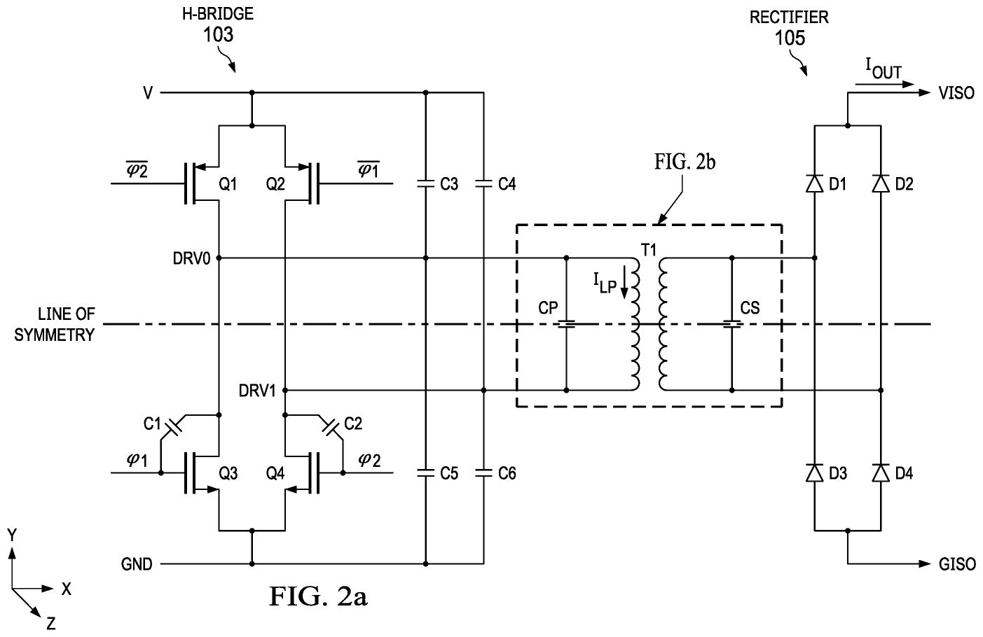

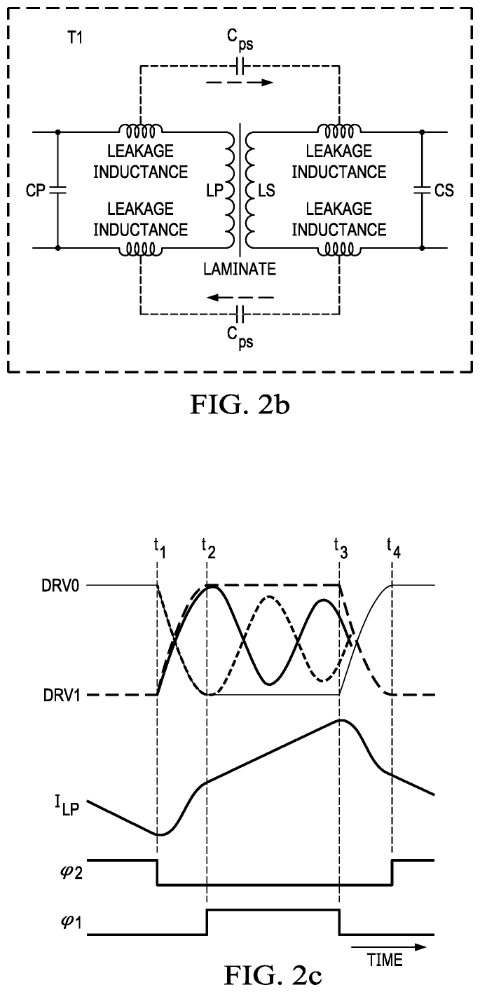

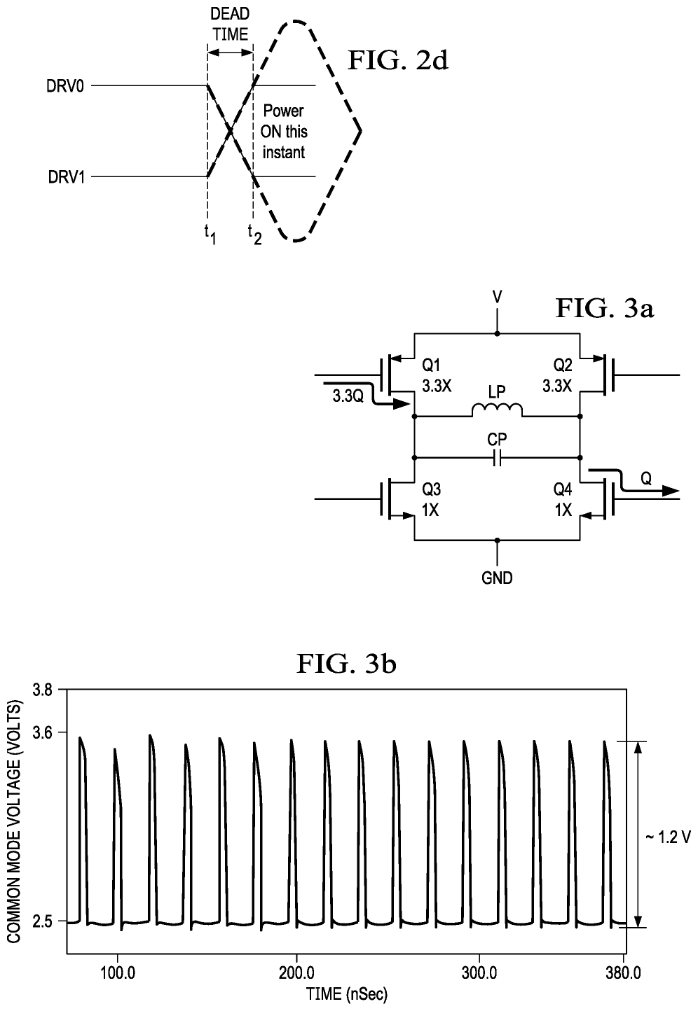

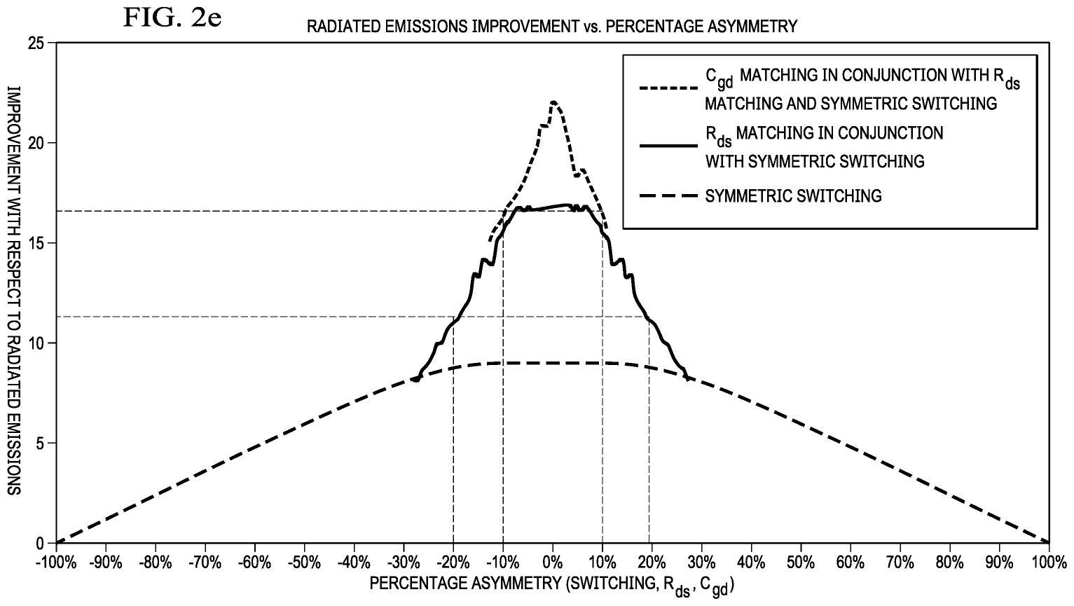

The H-bridge switching circuit 103 is parasitic-compensated to adjust for polarity-based parasitic differences between p-type and n-type transistors, as will be further discussed in turn with reference to FIGS. 2a-5b. The transformer T1 has a physically symmetric configuration such that both its capacitive and inductive mid-points are substantially co-located. In some example cases, each of the primary and secondary inductors includes a first half-cell portion and a second half-cell portion that is a replica of the first half-cell portion except that it is rotated about an axis, and those two half-cell portions connect at a point that is both the capacitive and inductive mid-point of that inductor (such as further discussed with reference to the example inductor and transformer configurations shown in FIGS. 6c-d, 7a-d, and 8a-d). Any asymmetry of such inductors is relatively small and can be attributed to, for example, real world process limitations, or feedline differences (such as with FIGS. 6c-d) or movement of a feedpoint (such as with FIGS. 7a-d and 8a-d), as will be discussed in turn. Thus, the degree of co-location between the capacitive and inductive mid-points of the transformer T1 can vary within a tolerance attributable to that relatively small asymmetry. Furthermore, note that larger inductors can have a larger tolerance on the degree of co-location, as will be appreciated (the larger the symmetrical parts of the inductor, the less relevant the asymmetrical parts of that inductor become). Note that a feedpoint refers to a point of a transformer inductor that couples to a feedline, and a feedline refers to the conductive pathway (or at least a portion of that pathway) by which excitation is applied to the feedpoint of that inductor.

In some such embodiments, transformer T1 is implemented as an integrated laminate transformer, wherein the primary and secondary windings are printed or otherwise formed on opposing sides of a laminate structure (e.g., bismaleimide triazine (BT) resin, or other suitable dielectric material). Any number of turn ratios can be used, depending on the given application. In this example case, diodes D1-D4 of the rectifier 105 are symmetrically laid out in a full-wave rectifier, so as to convert AC output of transformer T1 back to DC. As will be appreciated, diodes D1-D4 can be implemented with any number of diode technologies, such as rectifier diodes, Schottky diodes, or MOSFET diodes (also called diode-connected MOSFETs), to name a few examples. In any such cases, layout symmetry can be maintained. As will be further appreciated, the hysteretic comparator 107 provides a feedback control loop of the power converter, so as to maintain a stable output voltage VISO (e.g., low overshoots and undershoots) during changes or transients in the load. Capacitor C7 blocks or otherwise reduces low frequency noise and DC components on the feedback path between comparator 107 and control 102.

FIGS. 2a-d collectively illustrate operational details of the H-bridge switching circuit 103 and transformer T1, in accordance with some embodiments of the present disclosure. As can be seen, the circuit is balanced about an imaginary line of symmetry. While the degree of symmetry can vary from one embodiment to the next, in this particular example embodiment, each of the H-bridge switching circuit 103 and transformer T1, as well as the rectifier 105 connected to the secondary of the transformer T1, can be laid out in a symmetric half-cell fashion so as to be substantially balanced about the line of symmetry.

As can be seen, the line of symmetry passes through the center of transformer T1 splitting each of the primary and secondary inductors (LP and LS, respectively), into two substantially equal divisions. As a result, any high-frequency common-mode switching current that passes from the primary to secondary (via parasitic capacitance Cps) is cancelled by the image common-mode current from other side, as generally depicted with dashed lines in FIG. 2b. Symmetric zero voltage switching (ZVS) turn ON is achieved by using resonant capacitors CP and CS in parallel with leakage inductance (on both primary and secondary sides, as can be seen in FIG. 2b). The resulting LC tank circuit (CP in parallel with leakage inductance on primary-side and CS in parallel with leakage inductance on secondary-side, in combination with parasitic Cps) establishes the switching differential, which in turn substantially reduces the common-mode current. The ZVS OFF time (dead-time) is the half-period of the resonant frequency of leakage inductance, CP, and CS. The ZVS ON time is extended so that higher peak current can be achieved giving higher output current.

As will be appreciated in light of this disclosure, this architecture allows for symmetric switching. In more detail, and as can be seen in the timing diagram of FIG. 2c, the drive signals DRV0 and DRV1 output by the H-bridge switching circuit 103 are differential in nature, and they cannot both be high at the same time. At time t₁, drive signal col is low and drive signal φ2 transitions from high to low, which in turn causes DRV0 to begin its transition from high to low and DRV1 to begin its transition from low to high. In particular, when both the drive signals col and φ2 are low, inductor LP has a finite current flowing and capacitor CP is charged to a certain voltage. At this point, capacitor Cp and effective inductance from inductors LP and LS collectively form an LC tank circuit. This LC tank circuit resonates at its resonant frequency. This resonance drives the DRV1 signal high and DRV0 signal low. At time t₂, drive signal φ1 transitions from low to high and ZVS turn ON occurs when dv/dt is close to zero (hence ZVS turn ON). At time t₃, drive signal col transitions from high to low, which in turn causes DRV0 to begin its transition from low to high and DRV1 to begin its transition from high to low, and ZVS turn OFF occurs when transformer peak current (ILP) is reached. At time t₄, drive signal φ2 transitions from low to high, and the process repeats after dead-time concludes. The dead-time is the half-period of the resonant frequency of LC tank circuit.

Note that the resonate frequency is a function of the primary inductance and net capacitance across it. Depending upon the implementation, the frequency and/or the amplitude of the resonance might not match the desired OFF time. The amplitude of the resultant sinusoid will be a function of peak current (ILP) through the primary inductor. In the example case of FIG. 2d where the amplitude of the resultant sinusoid is much greater than the supply value (V−GND), ZVS can be achieved by timing the turn ON of the H-bridge 103 when DRV0 and DRV1 are close enough to their final settled values. As will be appreciated, this helps in preserving the charge and maintaining symmetricity in drive and effectively acts like a compromise between no ZVS and a proper ZVS.

The drive signals φ1 and φ2 and their symmetrical complementary counterparts φ̅1̅ and φ̅2̅ can be generated, for example, from a high-frequency clock included in digital control 102, or in non-overlap drives 104a-b, or otherwise accessible to the control block 101, and digitally divided down for a desired ZVS turn on. As best seen in FIG. 2c, the ZVS ON time is extended so that higher peak current (ILP) through the primary inductor can be achieved giving higher output current, I_{OUT}. This tradeoff causes the converter to operate at a frequency lower than the resonant frequency of the LC tank circuit. The converter can thus be referred to as a quasi-resonant converter. As will be appreciated, the ZVS topology allows the LC tank resonance to reverse the charge on the capacitance (CP and CS) on the two nodes without using power from the supply, which in turn helps with keeping the converter efficiency higher by compensating for the extra power required to drive the higher resistance PMOS FETs, compared to a cross-coupled PMOS stage.

In any such cases, note that capacitor CP can be part of the transformer T1 (e.g., on the laminate) in some embodiments, or in other embodiments can be part of the H-bridge switching circuit 103, or in still other embodiments be deployed independent of both 103 and T1. Likewise, note that capacitor CS can be part of the transformer T1 (e.g., on the laminate), or part of the rectifier 105, or deployed independent of both T1 and 105. Further note that either or both of CP and CS can be discrete capacitors, or an amount of parasitic capacitance sufficient to allow for ZVS or resonant operation, or a combination of both discrete and parasitic capacitance. In any such cases, the net resulting capacitance CP and CS (whether parasitic capacitance, intentional discrete capacitance, or some combination) is sufficient to achieve ZVS and resonant converter action at a given frequency of operation. Numerous such embodiments and variations will be apparent in light of this disclosure.

With further reference to FIG. 2a, the H-bridge switching circuit 103 is parasitic-compensated. In more detail, the PMOS transistors Q1 and Q2 of the high-side are sized larger so that their ON-resistance (R_{ds}) substantially matches the ON-resistance (R_{ds}) of NMOS transistors Q3 and Q4 of the low-side. Normally, a PMOS transistor has an R_{ds} that is considerably more than the R_{ds} of a similarly sized NMOS transistor, due to lower mobility of p-type devices. Thus, the PMOS transistor can be increased in size by about 3.3× relative to the NMOS transistor size, so that PMOS transistor will have substantially the same R_{ds}. In addition, the NMOS transistors Q3 and Q4 of the low-side are implemented with an additional capacitor (C1 and C2, respectively) between the gate and drain, so that their gate-drain capacitance (C_{gd}) substantially matches the gate-drain capacitance (C_{gd}) of the larger PMOS transistors Q1 and Q2 of the high-side. Note that the R_{ds} and C_{gd} values for the PMOS and NMOS transistors need not be exactly the same; rather, they only need to be within an acceptable tolerance of one another. So, for instance, in some example cases, the R_{ds} values for the PMOS and NMOS transistors are substantially the same or otherwise substantially matched in that the R_{ds} values are within 25%, or 20%, or 15%, or 10%, or 5%, or 2%, or 1% of each other, or are within 10%, or 5%, or 2.5%, or 2%, or 1%, or 0.5%, or 0.25% of the same target R_{ds} value; likewise, the C_{gd} values for the PMOS and NMOS transistors are substantially the same or otherwise substantially matched in that the C_{gd} values are within 25%, or 20%, or 15%, or 10%, or 5%, or 2%, or 1% of each other, or are within 10%, or 5%, or 2.5%, or 2%, or 1%, or 0.5%, or 0.25% of the same target C_{gd} value. The tolerance may vary from one embodiment to the next, depending on the demands of the given application. Further note that the tolerance of C_{gd} may be different than the tolerance for R_{ds}. Further note that the absolute values of R_{ds} and C_{gd} can vary from one embodiment to the next, and the present disclosure is not intended to be limited to any particular range of values. In any such cases, the R_{ds} and C_{gd} mismatches between the PMOS and NMOS transistors are substantially compensated for, within a tolerance acceptable for the given application and the attendant EMI performance goal. To this end, and as will be appreciated, the greater the degree of matching with respect R_{ds} and C_{gd} between the PMOS and NMOS transistors, the greater the degree of performance with respect to radiated emissions, according to some embodiments.

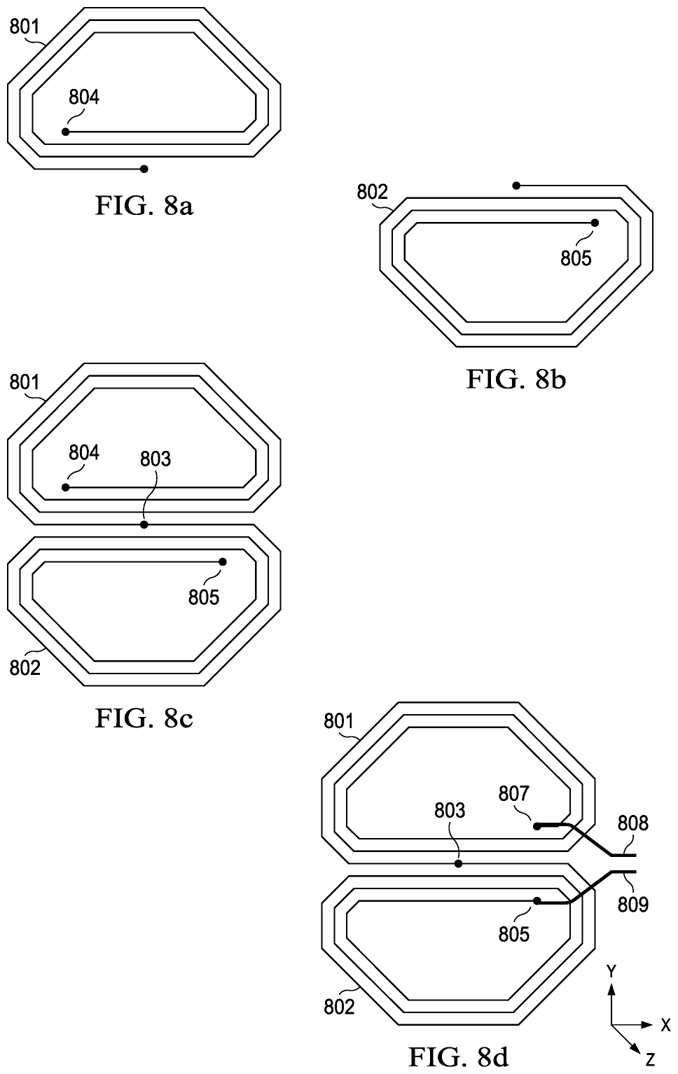

For instance, according to some embodiments, some reduction in radiated emissions is achieved when using a 25% matching threshold (whether matching between matched devices, or to a target tolerance), while further reduction in radiated emissions is achieved when using a 20% matching threshold, and still further reduction in radiated emissions is achieved when using a 10% matching threshold, and still further reduction in radiated emissions is achieved when using a 5% matching threshold, and still further reduction in radiated emissions is achieved when using a 2% matching threshold. Note that tighter matching thresholds with respect R_{ds} and C_{gd} may allow other parameters to be loosened while still maintaining desired EMI performance. For instance, in some example embodiments, tighter matching thresholds with respect R_{ds} and C_{gd} between the PMOS and NMOS transistors may allow for a higher degree of physical asymmetry with respect to the transformer (such as the asymmetry that results from moving a feedpoint such as discussed with the example embodiments of FIGS. 7d and 8d).

In addition to such R_{ds} and C_{gd} compensation, the H-bridge switching circuit 103 may also include capacitors C3, C4, C5, and C6, according to some embodiments. As can be seen, C3 and C4 are referenced to the input voltage V (such as V_{CC}), with C3 connected to the first node of the primary-side inductor of T1, and C4 connected to the second node of the primary-side inductor of T1. In a similar fashion, C5 and C6 are referenced to the primary-side ground (GND), with C5 connected to the first node of the primary-side inductor of T1, and C6 connected to the second node of the primary-side inductor of T1. As will be appreciated, capacitors C3, C4, C5, and C6 effectively operate to hold common-mode at V/2 during transitions. These capacitors also help to reduce, by capacitive voltage division, any stray charge injected by the drive power MOSFETs Q1-Q4.

FIG. 2e illustrates improvements, with respect to radiated emissions, that can be achieved with an H-bridge switching circuit and transformer architecture, in accordance with some embodiments of the present disclosure. In particular, and as can be seen, symmetric switching on its own can yield about a 5-10% improvement (reduction) in radiated emissions. In addition, matching the R_{ds} values of the PMOS and NMOS transistors within 20% of a target R_{ds} value, in combination with symmetric switching, can improve the radiated emissions more than 10%, while matching the R_{ds} values of the PMOS and NMOS transistors within 10% of a target R_{ds} value can improve emissions more than 15%. In addition, matching the C_{gd} values of the PMOS and NMOS transistors within 20% of a target C_{gd} value, in combination with symmetric switching and R_{ds} matching, can even further improve the radiated emissions more than 18%, while matching the C_{gd} values of the PMOS and NMOS transistors within 10% of a target C_{gd} value can improve emissions more than 20%. As will be further appreciated, a 5% match in the R_{ds} and/or C_{gd} values will further improve radiated emissions. In this regard, note that the degree of each of symmetric switching, R_{ds} matching, and C_{gd} matching can be tuned to achieve a desired performance improvement with respect to radiated emissions.

H-Bridge Switching Circuit

As previously explained, PMOS and NMOS are not symmetric by design, particularly with respect to on-resistance R_{ds} and gate-drain capacitance C_{gd}. To this end, the H-bridge switching circuit can be modified to provide better, more symmetrical performance. FIGS. 3a-5b collectively show the impact of each of these parasitic compensations individually and in combination.

In more detail, FIG. 3a illustrates an example H-bridge switching circuit configured with R_{ds} matching between NMOS and PMOS transistors, in accordance with an embodiment of the present disclosure. As can be seen, PMOS transistors Q1 and Q2 are sized 3.3× larger than NMOS transistors Q1 and Q2, so that all four transistors have substantially the same on-resistance R_{ds}. The previous discussion with respect to exact matching of on-resistance not being required is equally applicable here (substantially matched within a tolerance is fine). As will be appreciated, the absolute sizing and relative sizing may vary from one embodiment to the next, and the present disclosure is not intended to be limited to any particular one or set of sizing schemes. Rather, the sizing scheme can be tailored to any opposite polarity (n-type and p-type) transistors that can be matched for on-resistance. In any such case, and as can be seen in FIG. 3b, the matching R_{ds} of the NMOS (Q3 and Q4) and PMOS (Q1 and Q2) yields ˜1.2 volt common-mode peaks (peak-to-peak). This manifestation largely results because of asymmetric C_{gd}-based charge injection (the C_{gd} of the larger PMOS transistors Q1 and Q2 does not match the C_{gd} of the smaller NMOS transistors Q3 and Q4).

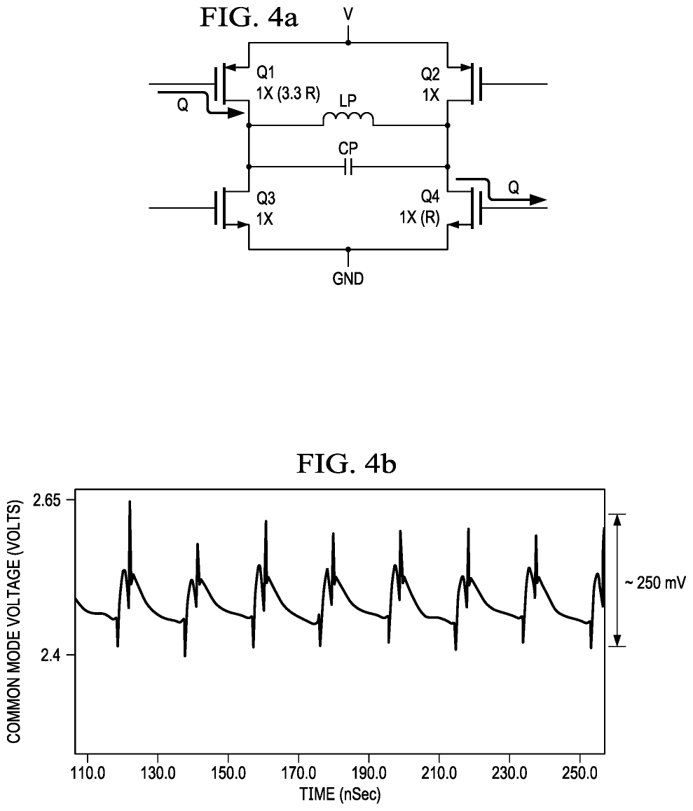

FIG. 4a illustrates an example H-bridge switching circuit configured with C_{gd}-only matching between NMOS and PMOS transistors, in accordance with an embodiment of the present disclosure. As can be seen, transistors Q1 and Q2 are substantially the same size as transistors Q3 and Q4, so C_{gd} of all four transistors substantially matches. However, the on-resistance R_{ds} of transistors Q1 and Q2 is relatively higher than that of transistors Q3 and Q4, due to lower mobility of carrier in p-type semiconductor (e.g., in silicon, mobility of holes is lower than mobility of electrons). As can be seen in FIG. 4b, matching C_{gd} of Q3 and Q4 to the C_{gd} of Q1 and Q2, without matching R_{ds}, yields approximately 250 millivolt common-mode peaks (peak-to-peak), at twice the switching frequency. The previous discussion with respect to exact matching of gate-drain capacitance not being required is equally applicable here (substantially matched within a tolerance is fine).

FIG. 5a illustrates an example H-bridge switching circuit configured with both R_{ds} and C_{gd} matching between NMOS and PMOS transistors. As can be seen, transistors Q1 and Q2 are sized 3.3× greater than transistors Q3 and Q4, so that all four transistors have substantially the same R_{ds}. In addition, transistors Q3 and Q4 are each C_{gd}-matched to transistors Q1 and Q2, so that all four transistors have substantially the same C_{gd}. The previous discussion with respect to exact matching of R_{ds} and C_{gd} not being required is equally applicable here (substantially matched R_{ds} and C_{gd} within a tolerance is okay). In particular, Q3 is configured with an additional capacitor C1 across its gate-drain junction, and Q4 is configured with an additional capacitor C2 across its gate-drain junction. As will be appreciated, capacitors C1 and C2, as well as any other capacitors provided herein, can be implemented with any number of capacitor technologies, such as metal-insulator-metal capacitors, metal-oxide-metal capacitors, or MOSFET capacitors, to name a few examples. An example MOSFET capacitor configuration is shown with respect to C1, in dashed lines in FIG. 5a (a similar configuration would apply to C2, to maintain symmetry). As will be further appreciated, the absolute value of capacitors C1 and C2 can vary from one embodiment to the next, based on the semiconductor process technology and materials used, and the present disclosure is not intended to be limited to any particular range of capacitance values. Rather, capacitors C1 and C2 can be tailored to any opposite polarity (n-type and p-type) transistors that can be matched for such capacitance. As can be seen in FIG. 5b, matching both R_{ds} and C_{gd} of Q3 and Q4 to R_{ds} and C_{gd} of Q1 and Q2, yields relatively low HO millivolts) common-mode peaks (peak-to-peak), at twice the switching frequency. As will be appreciated, this particular configuration gives the lowest EMI at the cost of some switching losses (slower switching speed). Further note that complete mitigation of common-mode voltage change is not required. Rather, relatively small common-mode voltage peaks that are within a tolerance suitable for a given application may be tolerated. For instance, in some cases, a peak-to-peak common-mode voltage of less than 200 millivolts may be acceptable for 5Vin 5Vout or 3.3Vin 3.3Vout isolated DC-DC power converters, or less than 150 millivolts, or less than 100 millivolts, or otherwise less than an acceptable percentage of the input or output voltages of the isolated DC-DC power converter.

Transformer

FIGS. 6a-b collectively illustrate a symmetric transformer T1 configured in accordance with an embodiment of the present disclosure. As can be seen, the transformer T1 generally includes a primary inductor LP and a second inductor LS. In this example case, the primary inductor LP includes Lp1, Lp2, and Lp3, and the secondary inductor LS includes Ls1, Ls2, and Ls3. In addition, there is parasitic capacitance between LP and LS, as generally depicted in dashed lines. As will be discussed in turn with respect to FIGS. 6c-d, Lp1 and Lp2 are symmetrical half-cell portions of LP, and Lp3 is the relatively small asymmetrical portion of LP that is attributable to a difference in the feedline structures to the corresponding feedpoints of Lp1 and Lp2. Likewise, Ls1 and Ls2 are symmetrical half-cell portions of LS, and Ls3 is the relatively small asymmetrical portion of LS that is attributable to a difference in the feedline structures to the corresponding feedpoints of Ls1 and Ls2.

As can be seen in the example embodiment of FIG. 6b, the transformer T1 is an integrated laminate transformer, which includes inductors LP and LS printed or otherwise formed on opposite sides of a laminate structure. As can be further seen, wire bonds are used to connect LP to the H-bridge switching circuit 103, and LS to the rectifier 105, although other interconnect mechanisms can be used. As will be appreciated, each of 103 and 105 can be formed on a semiconductor die. Standard or proprietary process technologies and materials can be used, as will be appreciated.

FIG. 6c illustrates an example inductor layout that can be used for LP (where x=P) or LS (where x=S) of transformer T1, configured in accordance with an embodiment of the present disclosure. Of course, LP and LS for a given transformer T1 design may have a different number of turns, depending on the desired turn ratio. In any such cases, and as can be seen, the inductor of this example embodiment is 8-shaped and includes portion 601 and portion 602, connected together at a center point 603 of the inductor, wherein portion 602 is a replica (copy) of portion 601 that has been rotated 180 degrees about the z-axis (coming out of page); hence, they are symmetric half-cell portions. Note that center point 603 is both the inductive mid-point and the capacitive mid-point of the 8-shaped inductor. The previous discussion with respect to substantial co-location, and that exact co-location is not required, equally applies here. The feedline to feedpoint 604 includes portions 606 and 607, and the feedline to feedpoint 605 includes portions 608 and 609. Each of these portions 601-609 may be implemented with any suitable conductive material, such as copper.

As can be further, there is a slight asymmetry with respect to the two feedlines, which in turn provides a slight difference inductance. This slight difference is presented as Lp3 or Ls3 in FIG. 6a. In more detail, some of the feedline segments are symmetrical as they are common to both feedlines, and thus can be attributed to the main inductance to which they feed. In this example case, segment 606B corresponds to segment 608, and segment 607E corresponds to segment 609. So, the inductance of segments 606B and 607E can be grouped with the inductance of L601; likewise, the inductance of segments 608 and 609 can be grouped with the inductance of L602. The only remaining feedline segments not yet accounted for are 606A, 606C, and 607D. Thus, the inductance of these segments can be represented as Lx3, which can be either of Lp3 or Ls3. Nonetheless, the inductor has a high degree of symmetry. For instance, in some example embodiments, the inductance of each of L601 (including segments 606B and 607E) and L602 (including segments 608 and 609) is 5× or larger than the inductance of segments 606A, 606C, and 607D, or 10× or larger, or 20× or larger, or 50× or larger, or 100× or larger. Connection points at 610 allow for connection (e.g., wire bonding or other interconnect) to 103 (if x=P) or 105 (if x=S) of the semiconductor die. This interconnection may also be implemented in a symmetrical fashion.

FIG. 6d illustrates another example inductor layout that can be used for LP (where x=P) or LS (where x=S) of transformer T1, configured in accordance with an embodiment of the present disclosure. The previous relevant discussion with respect to FIG. 6c is equally applicable here. In this example case, the inductor is 0-shaped and includes portion 651 and portion 652, connected together at a center point 653 of the inductor, wherein portion 652 is a replica (copy) of portion 651 that has been rotated 180 degrees about the x-axis; hence, they are symmetric half-cell portions. Note that center point 653 is both the inductive mid-point and the capacitive mid-point of the O-shaped inductor. The previous discussion with respect to exact co-location not being required equally applies here. The feedline to feedpoint 654 includes portions 656 and 657, and the feedline to feedpoint 655 includes portions 658 and 659. As can be further seen, segment 656A corresponds to segment 658, and segment 657D corresponds to segment 659. So, the inductance of segments 656A and 657D can be grouped with the inductance of L651; likewise, the inductance of segments 658 and 659 can be grouped with the inductance of L652. The only remaining feedline segments not yet accounted for are 656B and 657C. Thus, the inductance of these segments can be represented as Lx3, which can be either of Lp3 or Ls3. Nonetheless, the inductor has a high degree of symmetry. For instance, in some example embodiments, the inductance of each of L651 (including segments 656A and 657D) and L652 (including segments 658 and 659) is 5× or larger than the inductance of segments 656B and 657C, or 10× or larger, or 20× or larger, or 50× or larger, or 100× or larger. Connection points at 660 allow for connection (e.g., wire bonding or other interconnect) to 103 (if x=P) or 105 (if x=S) of the semiconductor die. This interconnection may also be implemented in a symmetrical fashion.

FIGS. 7a-d collectively illustrate a primary inductor of a symmetric transformer, in accordance with another embodiment of the present disclosure. In more detail, FIG. 7a shows a half-cell portion 701 of the inductor, which includes a feedpoint 704. FIG. 7b shows the other half-cell portion 702 of the inductor, which includes a feedpoint 705. As can be seen, half-cell portion 702 is a replica (copy) of half-cell portion 701 that has been rotated 180 degrees about the z-axis (coming out of page). FIG. 7c shows the half-cell portions 701 and 702 connected at 703, to provide a symmetric 8-shaped inductor. Note that this example inductor has 2 turns, and point 703 is the location of both the capacitive and inductive mid-points of the inductor. The previous discussion with respect to exact co-location of these mid-points not being required equally applies here. In some embodiments, it is desirable to have the feedpoints on the same side (to facilitate easier connection). To this end, and as can be seen in FIG. 7d, feedpoint 705 is extended or otherwise moved to feedpoint 707 by adding extension 706, so as to line up with feedpoint 704. Thus, the feedlines 708 and 709 can be more easily attached to the respective feedpoints 704 and 707. Since the voltage difference right at the center of the coil is relatively small, the small difference in symmetry causes a negligible voltage across the extension 706. Thus, the feedpoints can be moved to a desired location without sacrificing symmetry. Half-cell portion 701, half-cell portion 702, and extension 706 can be thought of as Lp1, Lp2, and Lp3, respectively, of FIG. 6a. Because 706 is much smaller than 701 and 702 (e.g., combined inductance of 701 and 702 is at least 5× larger than inductance of 706, or at least 10× or larger, or at least 20× or larger, or at least 50× or larger, or at least 100× or larger), the voltage across 706 is relatively small or otherwise negligible.

FIGS. 8a-d collectively illustrate a secondary inductor of a symmetric transformer, in accordance with another embodiment of the present disclosure. In more detail, FIG. 8a shows a half-cell portion 801 of the inductor, which includes a feedpoint 804. FIG. 8b shows the other half-cell portion 802 of the inductor, which includes a feedpoint 805. As can be seen, half-cell portion 802 is a replica (copy) of half-cell portion 801 that has been rotated 180 degrees about the z-axis (coming out of page). FIG. 8c shows the half-cell portions 801 and 802 connected at 803, to provide a symmetric 8-shaped inductor. Note that this example inductor has 3 turns, and point 803 is the location of both the capacitive and inductive mid-points of the inductor. The previous discussion with respect to exact co-location of these mid-points not being required equally applies here. In some embodiments, it is desirable to have the feedpoints on the same side (to facilitate easier connection). To this end, and as can be seen in FIG. 8d, feedpoint 804 is shortened or otherwise moved to feedpoint 807 by removing (or simply not forming) a corresponding portion of 801, so as to line up with feedpoint 805. Thus, the feedlines 808 and 809 can be more easily attached to the respective feedpoints 805 and 807. Half-cell portion 801, half-cell portion 802, and the missing portion of 801 can be thought of as Ls1, Ls2, and Ls3, respectively, of FIG. 6a. Because the missing portion of 801 is much smaller than 801 and 802 (e.g., combined inductance of 801 and 802 is at least 5× larger than inductance of missing portion, or at least 10× or larger, or at least 20× or larger, or at least 50× or larger, or at least 100× or larger), the resulting asymmetry is relatively small or otherwise negligible.

Note that the primary inductor of FIGS. 7a-d can be used in conjunction with the secondary inductor of FIGS. 8a-d to provide a transformer with a 2/3 turn ratio. In some such example cases, the transformer has a capacitive mid-point and an inductive mid-point that at least partially overlap with one another (such as the case where point 703 is co-located with point 803, or within an acceptable tolerance of that point), and the line of symmetry passes through at least one of capacitive mid-point and the inductive mid-point. Numerous other configurations will be appreciated.

As explained above, such symmetry in the H-bridge switching circuit 103 and transformer T1 substantially reduces common-mode voltage peaks across the transformer. For example, consider the example case where the converter is a DC-DC converter (e.g., 5Vin 5Vout or 3.3Vin 3.3Vout), a symmetrically driven transformer with symmetric 8-shaped primary and secondary windings yields about a 6 dB or more reduction in common-mode current, compared to an otherwise comparable a DC-DC converter having an asymmetric transformer (e.g., spiral inductors). In addition, using both R_{ds} and C_{gd} matching between NMOS and PMOS power FETs (Q1-4) of the H-bridge switching circuit 103, the common-mode voltage peak across the primary of the transformer is less than 100 millivolts, which is relatively much lower than the common-mode peak attributable to an uncompensated H-bridge switching circuit. Other embodiments may have different results, as will be appreciated.

Supply Network

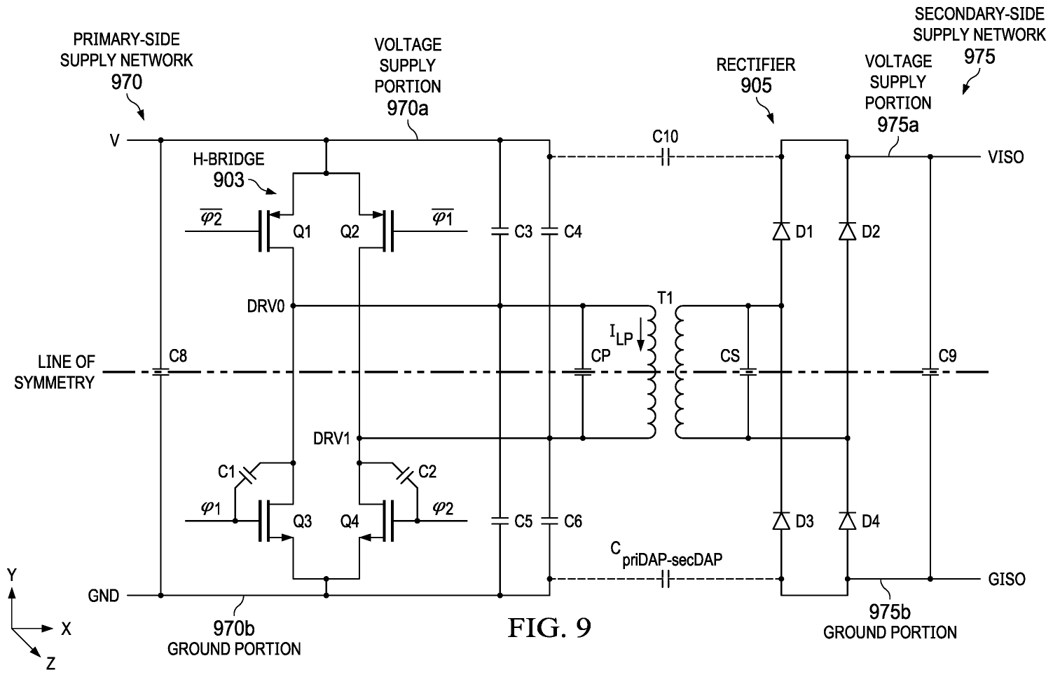

As previously explained, the supply network of the power converter may include symmetrical features as well. For instance, bond-wires and trace lengths of the voltage supply (V) and ground pathways (GND) can be laid out in a symmetrical fashion, so as to provide symmetric power feed paths to the H-bridge switching circuit 103 and rectifier 105. Such symmetry helps to maintain out-of-phase noise (e.g., (V_{CC}+GND)/2) at a constant level. Likewise, the rectifier 105 can be laid out in a symmetric half-cell fashion. Also, decoupling capacitors can be connected between the supply and ground of the primary-side and the secondary-side, respectively, to help reduce supply noise. Also, an additional capacitor can be added to compensate for parasitic capacitance associated with the primary and secondary die attach pads (priDAP and secDAP). Such features are depicted in FIG. 9, which is similar to the architecture shown in FIG. 2a, and that discussion is equally applicable here. In addition, that architecture has been modified to include a symmetric supply network on the primary-side and the secondary side, and compensation for priDAP/secDAP parasitic capacitance.

As can be seen, the primary-side supply network 970 is laid out in symmetric fashion, and includes a voltage supply portion 970a, a ground portion 970b, and decoupling capacitor C8. Likewise, the secondary-side supply network 975 is laid out in symmetric fashion, and includes a voltage supply portion 975a, a ground portion 975b, and decoupling capacitor C9. Note that, in some embodiments, capacitors C3-C6 may also be included in supply network 970, and/or diodes D1-D4 or rectifier 905 may be included in supply network 975. In any such case, the supply networks 970 and 975 are symmetrical about the line of symmetry, so as to provide symmetric power feed paths to the inverter and rectifier circuitry.

So, for instance, supply network 970 can be implemented with two half-cell portions, where the upper half-cell portion includes voltage supply portion 970a, which in this example embodiment includes the voltage supply V routing traces and any bond-wires or componentry above and up to the line of symmetry, including the top half of C8 (as well as C3 and C4, in some such embodiments). In such a case, the lower half-cell portion can be a copy (replica) of the upper half-cell portion that is rotated 180 degrees about the x-axis, so as to provide the ground portion 970b, which in this example includes the first ground (GND) routing traces and any bond-wires or componentry below and up to the line of symmetry, including the bottom half of C8 (as well as C5 and C6, in some such embodiments).

Likewise, supply network 975 can be implemented with two half-cell portions, where the upper half-cell portion includes voltage supply portion 975a, which in this example embodiment includes the output voltage VISO routing traces and any bond-wires or componentry above and up to the line of symmetry, including the top half of C9 (as well as D1 and D2, in some such embodiments). In such a case, the lower half-cell portion can be a replica (copy) of the upper half-cell portion that is rotated 180 degrees about the x-axis, so as to provide the ground portion 975b, which in this example includes the second ground (GISO, which is isolated from GND) routing traces and any bond-wires or componentry below and up to the line of symmetry, including the bottom half of C9 (as well as D3 and D4, in some such embodiments). As previously explained, the rectifier 905 can also be laid out in half-cell fashion, about the line of symmetry, as can the other components in the signal chain (e.g., CS, T1, CP, and 903). Any half-cell portion may include componentry from any combination of these, so long as the isolation barrier is ultimately maintained.

As will be appreciated, decoupling capacitors C8 and C9 can be used in cases where, for example, the input supply V and/or output supply VISO are relatively noisy. By way of example, consider the case where power-ground parasitic inductance (from bond-wires and lead-fingers) contribute to 3Vp-p supply noise for 5Vin 5Vout. In a typical design, ground routing is stronger (more robust or otherwise asymmetrical) relative to power routing, which causes a common-mode peak while driving the transformer. Thus, by making the power and ground paths symmetric (on one or both the primary-side and secondary-side), along with driver, transformer and rectifier symmetry as variously provided herein, the common-mode noise can be reduced or otherwise tuned to be below a desired threshold.

As can further be seen in the example embodiment of FIG. 9, a parasitic capacitance associated with the primary and secondary die attach pads (C_{priDAP-secDAP}) effectively couples the primary-side GND to the secondary-side GISO. The parasitic capacitance can be compensated with a matching capacitance (C10) coupled between the primary-side V to the secondary-side VISO. Consider the example case, for instance, where C_{priDAP-secDAP} provides a parasitic capacitance of about 900f, which can cause an unbalanced common-mode current. To this end, a comparable value capacitor C10 can be added in a symmetric fashion, for example, on the laminate layer of the transformer, to balance such parasitic capacitance. Other parasitics that introduce an asymmetric common-mode can similarly be compensated, to add a further degree of symmetry to the configuration.

Variations will be appreciated. For instance, the p-type transistors are shown as being connected to the high-side of the converter, and the n-type transistors are shown as being connected to the low-side of the converter. In other embodiments, this arrangement can be reversed, such that the n-type transistors are connected to the high-side of the converter, and the p-type transistors are connected to the low-side of the converter. To this end, the first and second polarities of the transistors making up the H-bridge switching circuit can be switched between the high-side and low-side.

### FURTHER EXAMPLE EMBODIMENTS

Example 1 is an integrated circuit, including: a transformer having a primary-side inductor and a secondary-side inductor, each of the primary-side inductor and the secondary-side inductor including a first half-cell portion and a second half-cell portion that is a replica of the first half-cell portion except that it is rotated about an axis, and those two half-cell portions are connected to one another to provide the corresponding inductor; and an H-bridge switching circuit operatively coupled to the primary-side inductor, the H-bridge switching circuit including first and second transistors of a first polarity, and third and fourth transistors of a second polarity, wherein the first, second, third, and fourth transistors have substantially the same on-resistance and substantially the same gate-drain capacitance.

Example 2 includes the subject matter of Example 1, wherein an imaginary line of symmetry divides the secondary-side inductor of the transformer into the corresponding first and second half-cell portions, the integrated circuit further including: a rectifier operatively coupled to the secondary-side of the transformer, and including a plurality of diodes arranged and connected symmetrically about the line of symmetry.

Example 3 includes the subject matter of Example 1 or 2, wherein an imaginary line of symmetry divides the primary-side of the transformer into the corresponding first and second half-cell portions, the integrated circuit further including: a control block to provide drive signals for driving the first, second, third, and fourth transistors of the H-bridge switching circuit, the control block arranged and connected symmetrically about the line of symmetry.

Example 4 includes the subject matter of Example 3, further including: a hysteretic comparator to provide a feedback signal to the control block.

Example 5 includes the subject matter of Example 3 or 4, wherein the control block comprises: a digital control circuit to generate control signals; a first non-overlap drive circuit to generate a first pair of complementary non-overlapping drive signals for driving one of the first and second transistors of the first polarity and one of the third and fourth transistors of the second polarity; and a second non-overlap drive circuit to generate a second pair of complementary non-overlapping drive signals for driving the other of the first and second transistors of the first polarity and the other of the third and fourth transistors of the second polarity.

Example 6 includes the subject matter of Example 5, wherein the control block further comprises: first, second, third, and fourth drivers each to receive a corresponding one of the non-overlapping drive signals and drive the first, second, third, and fourth transistors, respectively.

Example 7 includes the subject matter of any of Examples 1 through 6, wherein the transformer has a capacitive mid-point and an inductive mid-point, and the capacitive mid-point is co-located with the inductive mid-point.

Example 8 includes the subject matter of any of Examples 1 through 7, wherein the on-resistance of each of the first, second, third, and fourth transistors is within 10% of a same target value, and the gate-drain capacitance of each of the first, second, third, and fourth transistors is within 10% of a same target value.

Example 9 includes the subject matter of any of Examples 1 through 8, wherein the on-resistance of each of the first, second, third, and fourth transistors is within 5% of a same target value, and the gate-drain capacitance of each of the first, second, third, and fourth transistors is within 5% of a same target value. In other such Examples, the on-resistance of each of the first, second, third, and fourth transistors is within 5% of a same target value, and the gate-drain capacitance of each of the first, second, third, and fourth transistors is within 10% of a same target value. In still other such Examples, the on-resistance of each of the first, second, third, and fourth transistors is within 10% of a same target value, and the gate-drain capacitance of each of the first, second, third, and fourth transistors is within 5% of a same target value.

Example 10 includes the subject matter of any of Examples 1 through 9, further including a supply network including a voltage supply portion and a ground portion, wherein respective trace lengths of the voltage supply portion and the ground portion are laid out in a symmetrical fashion, so the voltage supply portion is symmetrical to the ground portion.

Example 11 is an integrated circuit, including: a transformer having a primary-side inductor and a secondary-side inductor, each of the primary-side inductor and the secondary-side inductor including a first portion and a second portion that is a replica of the first portion except that it is rotated about an axis, and those two portions are connected to one another to provide the corresponding inductor, wherein an imaginary line of symmetry divides each of the primary-side and secondary-side inductors into the respective first and second portions; and an H-bridge switching circuit operatively coupled to the primary-side inductor, the H-bridge switching circuit including first and second transistors of a first polarity, and third and fourth transistors of a second polarity, wherein the first, second, third, and fourth transistors each have an on-resistance within 10% of a same target on-resistance, and a gate-drain capacitance within 10% of a same target gate-drain capacitance. So, for example, if the target on resistance is 100 ohms, then the first, second, third, and fourth transistors each have an on-resistance within the range of 90 to 110 ohms.

Example 12 includes the subject matter of Example 11, further including: a rectifier operatively coupled to the secondary-side of the transformer, and including a plurality of diodes arranged and connected symmetrically about the line of symmetry.

Example 13 includes the subject matter of Example 11 or 12, further including: a control block to provide drive signals for driving the first, second, third, and fourth transistors of the H-bridge switching circuit, the control block arranged and connected symmetrically about the line of symmetry; and/or a hysteretic comparator to provide a feedback signal to the control block.

Example 14 includes the subject matter of Example 13, wherein the control block comprises: a digital control circuit to generate control signals; a first non-overlap drive circuit to generate a first pair of complementary non-overlapping drive signals for driving one of the first and second transistors of the first polarity and one of the third and fourth transistors of the second polarity; and a second non-overlap drive circuit to generate a second pair of complementary non-overlapping drive signals for driving the other of the first and second transistors of the first polarity and the other of the third and fourth transistors of the second polarity.

Example 15 includes the subject matter of any of Examples 11 through 14, wherein the first, second, third, and fourth transistors each have an on-resistance within 2.5% of the same target on-resistance, and a gate-drain capacitance within 2.5% of the same target gate-drain capacitance. In other such Examples, the on-resistance of each of the first, second, third, and fourth transistors is within 1% of a same target value, and the gate-drain capacitance of each of the first, second, third, and fourth transistors is within 2.5% of a same target value. In still other such Examples, the on-resistance of each of the first, second, third, and fourth transistors is within 2.5% of a same target value, and the gate-drain capacitance of each of the first, second, third, and fourth transistors is within 1% of a same target value.

Example 16 includes the subject matter of any of Examples 11 through 15, further including a supply network including a voltage supply portion and a ground portion, wherein the voltage supply portion is symmetrical to the ground portion about the line of symmetry.

Example 17 is an integrated circuit, including: a transformer having a primary-side inductor and a secondary-side inductor, wherein an imaginary line of symmetry divides each of the primary-side and secondary-side inductors into first and second portions; a rectifier operatively coupled to the secondary-side of the transformer, and including a plurality of diodes arranged and connected symmetrically about the line of symmetry; a supply network including a voltage supply portion and a ground portion, wherein the voltage supply portion is symmetrical to the ground portion about the line of symmetry; and an H-bridge switching circuit operatively coupled to the primary-side inductor, the H-bridge switching circuit including first and second p-type metal oxide semiconductor field effect transistors (MOSFETs) connected to the voltage supply portion of the supply network, and third and fourth n-type MOSFETs connected to the ground portion of the supply network, wherein the first, second, third, and fourth MOSFETs each have an on-resistance within 10% of a same target on-resistance, and a gate-drain capacitance within 10% of a same target gate-drain capacitance. The first and second portions of the primary-side inductor each have a primary-side feedpoint and are symmetric about the line of symmetry, except for a portion attributable to movement of the primary-side feedpoint of one of the portions of the primary-side inductor to be physically closer to the primary-side feedpoint of the other of the portions of the primary-side inductor. In addition, first and second portions of the secondary-side inductor each have a secondary-side feedpoint and are symmetric about the line of symmetry, except for a portion attributable to movement of the secondary-side feedpoint of one of the portions of the secondary-side inductor to be physically closer to the feedpoint of the other of the portions of the secondary-side inductor.

Example 18 includes the subject matter of Example 17, further including a control block to provide drive signals for driving the first, second, third, and fourth MOSFETs of the H-bridge switching circuit; and/or a hysteretic comparator operatively coupled to rectifier and to provide a feedback signal to the control block.

Example 19 includes the subject matter of Example 18, wherein the control block comprises: a digital control circuit to generate control signals; a first non-overlap drive circuit to generate a first pair of complementary non-overlapping drive signals for driving one of the first and second transistors of the first polarity and one of the third and fourth transistors of the second polarity; and a second non-overlap drive circuit to generate a second pair of complementary non-overlapping drive signals for driving the other of the first and second transistors of the first polarity and the other of the third and fourth transistors of the second polarity.

Example 20 includes the subject matter of any of Examples 17 through 19, wherein the transformer has a capacitive mid-point and an inductive mid-point, and the capacitive mid-point is co-located with the inductive mid-point.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

1. An integrated circuit, comprising:
a transformer having a primary-side inductor and a secondary-side inductor, each of the primary-side inductor and the secondary-side inductor including a first half-cell portion and a second half-cell portion that is a replica of the first half-cell portion except that it is rotated about an axis, and those two half-cell portions are connected to one another to provide the corresponding inductor; and
an H-bridge switching circuit operatively coupled to the primary-side inductor, the H-bridge switching circuit including first and second transistors of a first polarity, and third and fourth transistors of a second polarity, wherein the first, second, third, and fourth transistors have substantially the same on-resistance and substantially the same gate-drain capacitance.

2. The integrated circuit of claim 1, wherein an imaginary line of symmetry divides the secondary-side inductor of the transformer into the corresponding first and second half-cell portions, the integrated circuit further comprising:
a rectifier operatively coupled to the secondary-side of the transformer, and including a plurality of diodes arranged and connected symmetrically about the line of symmetry.

3. The integrated circuit of claim 1, wherein an imaginary line of symmetry divides the primary-side of the transformer into the corresponding first and second half-cell portions, the integrated circuit further comprising:
a control block to provide drive signals for driving the first, second, third, and fourth transistors of the H-bridge switching circuit, the control block arranged and connected symmetrically about the line of symmetry.

4. The integrated circuit of claim 3, further comprising:
a hysteretic comparator to provide a feedback signal to the control block.

5. The integrated circuit of claim 3, wherein the control block comprises:
a digital control circuit to generate control signals;
a first non-overlap drive circuit to generate a first pair of complementary non-overlapping drive signals for driving one of the first and second transistors of the first polarity and one of the third and fourth transistors of the second polarity; and
a second non-overlap drive circuit to generate a second pair of complementary non-overlapping drive signals for driving the other of the first and second transistors of the first polarity and the other of the third and fourth transistors of the second polarity.

6. The integrated circuit of claim 5, wherein the control block further comprises:
first, second, third, and fourth drivers each to receive a corresponding one of the non-overlapping drive signals and drive the first, second, third, and fourth transistors, respectively.

7. The integrated circuit of claim 1, wherein the transformer has a capacitive mid-point and an inductive mid-point, and the capacitive mid-point is co-located with the inductive mid-point.

8. The integrated circuit of claim 1, wherein the on-resistance of each of the first, second, third, and fourth transistors is within 10% of a same target value, and the gate-drain capacitance of each of the first, second, third, and fourth transistors is within 10% of a same target value.

9. The integrated circuit of claim 1, wherein the on-resistance of each of the first, second, third, and fourth transistors is within 5% of a same target value, and the gate-drain capacitance of each of the first, second, third, and fourth transistors is within 5% of a same target value.

10. The integrated circuit of claim 1, further comprising a supply network including a voltage supply portion and a ground portion, wherein respective trace lengths of the voltage supply portion and the ground portion are laid out in a symmetrical fashion, so the voltage supply portion is symmetrical to the ground portion.

11. An integrated circuit, comprising:
a transformer having a primary-side inductor and a secondary-side inductor, each of the primary-side inductor and the secondary-side inductor including a first portion and a second portion that is a replica of the first portion except that it is rotated about an axis, and those two portions are connected to one another to provide the corresponding inductor, wherein an imaginary line of symmetry divides each of the primary-side and secondary-side inductors into the respective first and second portions; and
an H-bridge switching circuit operatively coupled to the primary-side inductor, the H-bridge switching circuit including first and second transistors of a first polarity, and third and fourth transistors of a second polarity, wherein the first, second, third, and fourth transistors each have an on-resistance within 10% of a same target on-resistance, and a gate-drain capacitance within 10% of a same target gate-drain capacitance.

12. The integrated circuit of claim 11, further comprising:
a rectifier operatively coupled to the secondary-side of the transformer, and including a plurality of diodes arranged and connected symmetrically about the line of symmetry.

13. The integrated circuit of claim 11, further comprising:
a control block to provide drive signals for driving the first, second, third, and fourth transistors of the H-bridge switching circuit, the control block arranged and connected symmetrically about the line of symmetry; and
a hysteretic comparator to provide a feedback signal to the control block.

14. The integrated circuit of claim 13, wherein the control block comprises:
a digital control circuit to generate control signals;
a first non-overlap drive circuit to generate a first pair of complementary non-overlapping drive signals for driving one of the first and second transistors of the first polarity and one of the third and fourth transistors of the second polarity; and
a second non-overlap drive circuit to generate a second pair of complementary non-overlapping drive signals for driving the other of the first and second transistors of the first polarity and the other of the third and fourth transistors of the second polarity.

15. The integrated circuit of claim 11, wherein the first, second, third, and fourth transistors each have an on-resistance within 2.5% of the same target on-resistance, and a gate-drain capacitance within 2.5% of the same target gate-drain capacitance.

16. The integrated circuit of claim 11, further comprising a supply network including a voltage supply portion and a ground portion, wherein the voltage supply portion is symmetrical to the ground portion about the line of symmetry.

17. An integrated circuit, comprising:
a transformer having a primary-side inductor and a secondary-side inductor, wherein an imaginary line of symmetry divides each of the primary-side and secondary-side inductors into first and second portions;
a rectifier operatively coupled to the secondary-side of the transformer, and including a plurality of diodes arranged and connected symmetrically about the line of symmetry;
a supply network including a voltage supply portion and a ground portion, wherein the voltage supply portion is symmetrical to the ground portion about the line of symmetry; and
an H-bridge switching circuit operatively coupled to the primary-side inductor, the H-bridge switching circuit including first and second p-type metal oxide semiconductor field effect transistors (MOSFETs) connected to the voltage supply portion of the supply network, and third and fourth n-type MOSFETs connected to the ground portion of the supply network, wherein the first, second, third, and fourth MOSFETs each have an on-resistance within 10% of a same target on-resistance, and a gate-drain capacitance within 10% of a same target gate-drain capacitance;
wherein the first and second portions of the primary-side inductor each have a primary-side feedpoint and are symmetric about the line of symmetry, except for a portion attributable to movement of the primary-side feedpoint of one of the portions of the primary-side inductor to be physically closer to the primary-side feedpoint of the other of the portions of the primary-side inductor; and
wherein the first and second portions of the secondary-side inductor each have a secondary-side feedpoint and are symmetric about the line of symmetry, except for a portion attributable to movement of the secondary-side feedpoint of one of the portions of the secondary-side inductor to be physically closer to the feedpoint of the other of the portions of the secondary-side inductor.

18. The integrated circuit of claim 17, further comprising:
a control block to provide drive signals for driving the first, second, third, and fourth MOSFETs of the H-bridge switching circuit; and
a hysteretic comparator operatively coupled to rectifier and to provide a feedback signal to the control block.

19. The integrated circuit of claim 18, wherein the control block comprises:
a digital control circuit to generate control signals;
a first non-overlap drive circuit to generate a first pair of complementary non-overlapping drive signals for driving one of the first and second transistors of the first polarity and one of the third and fourth transistors of the second polarity; and
a second non-overlap drive circuit to generate a second pair of complementary non-overlapping drive signals for driving the other of the first and second transistors of the first polarity and the other of the third and fourth transistors of the second polarity.

20. The integrated circuit of claim 17, wherein the transformer has a capacitive mid-point and an inductive mid-point, and the capacitive mid-point is co-located with the inductive mid-point.
